(19) United States
(12) Patent Application Publication
(10) Pub. No.: US 2009/0124734 A1
(43) Pub. Date: May 14, 2009

(54) HALOGEN-FREE FLAME RETARDANT RESIN COMPOSITION

(75) Inventors: Eumi PYUN, Austin, TX (US); Paul V. Huynh, Pflugerville, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/934,951

(22) Filed: Nov. 5, 2007

(51) Int. Cl. C08K 5/53

(52) U.S. Cl. 524/133

(57) ABSTRACT

A composition includes a resin and a halogen-free flame retardant composition comprising at least a phosphinate or phosphinate salt. Also disclosed are compositions including a resin and a halogen-free flame retardant composition comprising a phosphinate or phosphinate salt and at least one additional material which is substantially free of halogen-containing compounds such as alumina trihydrate and/or magnesium hydroxide. One or more of these compositions may also include an expandable graphite.

### BACKGROUND

Resins are used in many industries and for many different purposes. Resins are widely used, for example, in the electrical and electronics industry as seals for splices and other equipment along with other applications. Resins used in such electrical and electronic applications generally require the possession of an acceptable set of electrical properties, a degree of flame resistance or flame retardancy and an acceptable level of processability. To meet increasingly sensitive environmental and safety considerations there is also now a desire to offer resin compositions that are substantially free of halogenated and halogen-containing compounds and materials. Currently available resins lack the ability to offer a desired set of electrical, performance, processing and flame resistance characteristics without the incorporation of halogenated or halogen-containing compounds and materials.

### SUMMARY

Briefly, in one aspect, the invention provides compositions that comprise at least one resin and a halogen-free flame retardant composition. The halogen-free flame retardant composition can comprise, for example, a phosphinate or phosphinate salt.

In another aspect, the invention provides compositions that comprise at least one resin and a halogen-free flame retardant composition where the halogen-free flame retardant composition comprises a phosphinate or phosphinate salt and at least one additional material that is substantially free of halogen-containing compounds.

In still other aspects, embodiments of the invention provide flame retardant resin compositions that possess a desired set of electrical properties, exhibit good processability and are substantially free of halogenated or halogen-containing compounds and materials.

### DETAILED DESCRIPTION OF PREFERRED EMBODIMENTS

In general, the present invention provides resin compositions that include a halogen-free flame retardant composition. The resin compositions are useful in myriad electrical and electronic applications. The term “halogen-free” refers to compositions that are substantially free of halogenated or halogen-containing compounds and materials. The resin compositions of the invention generally include or comprise a base resin that is substantially free of halogenated or halogen-containing compounds and materials such that when such resin compositions are used together with a halogen-free flame retardant composition, the resulting composition is also substantially free of halogenated or halogen-containing compounds or materials.

Useful base resin compositions include any resin or resin composition (including mixtures of two or more resins or resin compositions) that is useful in electrical or electronic applications and that is materially and physically compatible with the halogen free flame retardant compositions of the invention. Many commercially available resins, for example, are known for use as sealants or protectants for electrical splices or as sealants or protectants for use in electrical enclosures. Other resins and resin compositions are known and used in bonding applications such as those for aircraft, automotives, bicycles, ski parts and other industrial parts requiring high strength. Still more resins and resin compositions are known for uses as protective molds to cover cables, optical fiber connections and electronic components and equipment. All such resins and resin compositions may be used with the halogen-free flame retardant compositions of the present invention. Specific examples of useful resins include epoxy resins and urethane resins. Such resins are available commercially, for example, under the “Epon” tradename from Hexion Specialty Chemicals Co. of Columbus, Ohio, USA and under the “Isonate” tradename from Dow Chemical Company of Midland, Mich., USA.

The resistance of a flame retardant to flammability can be demonstrated by passing the flame retardant testing portion of industry standard UL 94. Detailed information regarding the standard is published by Underwriters Laboratory of Northbrook, Ill., USA. The halogen-free flame retardant compositions of the invention can comprise one or more phosphinate or phosphinate salt compounds. The flame retardant compositions may also include one or more additional non-halogenated flame retardant materials such as, for example, alumina trihydrate (Al₂O₃.3H₂O) or magnesium hydroxide (Mg(OH)₂). The phosphinate can be in the form of a phosphinate salt. More particularly, the phosphinate can be incorporated into the flame retardant composition as a metal phosphinate salt. Suitable metal phosphinate salts include, for example, aluminum phosphinate salts and zinc phosphinate salts.

In some embodiments of the invention, the halogen-free flame retardant composition comprises a blend composition that includes a phosphinate (or phosphinate salt) used together with one or more additional halogen-free flame retardant substances. Suitable such additional substances include alumina trihydrate (Al₂O₃.3H₂O) and magnesium hydroxide (Mg(OH)₂). When constituting a blend, the flame retardant compositions will generally comprise at least one phosphinate (or phosphinate salt) in an amount from about 17% to about 100% by weight of the total flame retardant composition, and one or more additional flame retardant substances in an amount from about 0% to about 83% by weight of the total flame retardant composition.

In certain embodiments, the resin compositions of the invention can include an expandable graphite together or in conjunction with the halogen-free flame retardant composition. The presence of the expandable graphite with the flame retardant composition comprising at least a phosphinate (or phosphinate salt) can provide advantageous results for flame resistance, electrical properties and processing characteristics. The presence of the expandable graphite and the amount and degree to which it is combined with the flame retardant composition will depend on a level of desired performance and will vary with the type of base resin with which both are combined. The optimization of any such formulation will be ascertainable to those of skill in the art. Generally, the expandable graphite will be used in an amount comprising from about 0% to about 5 to 10% or possibly more of the total resin-containing composition. More specifically, where an epoxy resin is employed as the base resin, for example, the flame retardant composition will preferably generally comprise from about 4% to about 50% by weight of the resin composition and the expandable graphite will preferably generally comprise from about 0 to about 3% by weight of the resin composition. Alternatively, where a urethane resin is employed as the base resin, the flame retardant composition will preferably generally comprise from about 14% to about 45% by weight of the resin composition and the expandable graphite will preferably generally comprise from about 0 to about 2% by weight of the resin composition.

The resin compositions of the invention can also include one or more additional additives, adjuvants, agents or materials (e.g., colorants, pigments, fillers, uv absorbers, conductive particles, etc.) compatible with the base resin composition. Many such additives, etc. are known and used in the art to manipulate or improve one or more desired characteristics of a resin composition. The resin compositions of the invention may, for example, include a viscosity modifier such as an aliphatic epoxy ester resin, an epoxidized soybean fatty acid ester, or another useful alternative viscosity modifier. One or more such viscosity modifiers can be used, for example, to lower the viscosity of the resin composition to improve processability and to aid in the dispersion and distribution of the flame retardant composition (and, if present, the expandable graphite) within the resin composition. Suitable viscosity modifiers for this purpose are available commercially, for example, as Vikoflex™ 7010 and Vikoflex™ 7170 from Arkema Inc. of Philadelphia, Pa., USA. Preferably, any additional material combined with the flame retardant composition and/or the resin composition will also be substantially free of halogenated or halogen-containing compounds and materials.

The resin compositions of the invention possess useful and desired physical properties and characteristics for electrical and electronic applications, are flame resistant and anti-flammable (including the ability to meet the standard of UL 94 testing) and can be readily processed. Examples of specific resin compositions according to the present invention follow together with an evaluation of their properties and performance. The examples are offered merely to aid in the understanding of the invention and are not to be construed as limiting the scope of the claims. Unless otherwise indicated, all parts and percentages are by weight.

### EXAMPLES

### Sample Preparation

For the examples that follow, resin samples were prepared and tested according to various embodiments of the invention. Each sample includes a base resin composition, a percentage of phosphinate, and a percentage of expandable graphite. The base resin composition used in Examples 1-11 was Epon™ 828, available from Hexion Specialty Chemicals of Columbus, Ohio, USA, together with an amine curative. The base resin composition used in Examples 12-25 was Isonate™ 143L, available from Dow Chemical Company of Midland, Mich., USA, reacted with a polyether and propylene glycol. The phosphinate used in all examples was OP1230 available from Clariant, Inc. of Muttenz, Switzerland. The expandable graphite used in all examples was Nyagraph™ 249 available from Nyacol, Inc. of Ashland, Mass., USA.

The samples used in each of the examples were prepared by mixing the resin composition, the phosphinate and the expandable graphite in the amounts and proportions identified for each example in Tables 1-2. All samples were hand mixed for 30-45 seconds using a wooden tongue depressor. After mixing, the mixed composition was poured into a mold.

### Test Methods:

Each of the samples for Examples 1-28 were evaluated according to the following test methods:

1. UL Flammability: As understood by those skilled in the art, a passing result for flammability means passing the industry standard test set forth by UL 94, Section 8. To conduct the test, a sample was exposed to an open flame. If the flame self-extinguished within less than 10 seconds and no dripping was observed, it was given a passing rating of “V0” according to test UL 94, Section 8.

2. Dry and Wet Dielectric Strength: Testing for dry and wet dielectric strength was performed according to the protocol of ASTM D149. In general, according to this test a sample was placed between two electrodes and power was increased until there was a dielectric failure. Testing for “dry” dielectric strength was performed at room temperature and 50% relative humidity. Testing for “wet” dielectric strength was performed upon exposure of the sample for 96 hours at a temperature of 23° C. and a relative humidity of 96%. A “Pass” for the dry dielectric strength test was given when the dielectrics were greater than or equal to 340 V/mil. A “Pass” for the wet dielectric strength test was given when at least 90% of the dry dielectric strength was retained (i.e., the wet dielectrics were greater than or equal to 306 V/mil).

3. Processability: A passing result for processability was given when, after mixing vigorously with a tongue depressor for 1 minute, either: a) the product had visually discernable unmixed areas of powder; or b) the product failed to cure.

The data of Table 1 indicate test results for Examples 1-14 in which varying amounts of phosphinate and expandable graphite were combined with an epoxy base resin composition.

TABLE 1

| | | Expandable | UL | Dry Dielectric | Wet Dielectric | |
|---|---|---|---|---|---|---|
| | Phosphinate | Graphite | Flammability | Strength | Strength | |
| Example | (wt %) | (wt %) | (Rating) | (V/mil) | (V/mil) | Processability |
| 1 | 50 | 0 | PASS (V0) | PASS (404) | PASS (406) | PASS |
| 2 | 45 | 0 | PASS (V0) | PASS (455) | PASS (457) | PASS |
| 3 | 30 | 0 | PASS (V0) | PASS (468) | PASS (583) | PASS |
| 4 | 20 | 0 | PASS (V0) | PASS (503) | PASS (530) | PASS |
| 5 | 18 | 0 | PASS (V0) | PASS (416) | PASS (530) | PASS |
| 6 | 15 | 0 | FAIL | PASS (462) | PASS (487) | PASS |
| 7 | 0 | 0 | FAIL | PASS (405) | PASS (397) | PASS |
| 8 | 15 | 2 | PASS (V0) | PASS (379) | PASS (457) | PASS |
| 9 | 15 | 5 | PASS (V0) | FAIL (213) | — | PASS |
| 10 | 4 | 3 | PASS (V0) | PASS (343) | PASS (332) | PASS |
| 11 | 3 | 3 | FAIL | — | — | PASS |
| 12 | 0 | 1 | FAIL | PASS (457) | PASS (343) | PASS |
| 13 | 0 | 2 | FAIL | PASS (407) | PASS (308) | PASS |
| 14 | 0 | 5 | FAIL | FAIL (252) | — | PASS |

The data from Examples 1-14 in Table 1 illustrate test results for various epoxy resin compositions. For those examples using a flame retardant composition that comprised phosphinate in the range of about 4% to about 50% by weight of the composition and an expandable graphite in the range of about 0% to about 3% by weight of the composition, a resin composition was provided that: (a) yielded passing results for flame resistance under the UL 94 standard; (b) met dielectric strength standards of ASTM D149; and (c) exhibited acceptable processability characteristics.

The data of Table 2 indicate test results for Examples 15-28 in which varying amounts of phosphinate and expandable graphite were combined with a urethane base resin composition.

TABLE 2

| | | Expandable | UL | Dry Dielectric | Wet Dielectric | |
|---|---|---|---|---|---|---|
| | Phosphinate | Graphite | Flammability | Strength | Strength | |
| Example | (wt %) | (wt %) | (Rating) | (V/mil) | (V/mil) | Processability |
| 15 | 50 | 0 | — | — | — | FAIL |
| 16 | 45 | 0 | PASS (V0) | PASS (455) | PASS (527) | PASS |
| 17 | 40 | 0 | PASS (V0) | PASS (391) | PASS (421) | PASS |
| 18 | 35 | 0 | PASS (V0) | PASS (415) | PASS (528) | PASS |
| 19 | 35 | 0 | PASS (V0) | PASS (388) | PASS (520) | PASS |
| 20 | 20 | 0 | PASS (V0) | PASS (485) | PASS (573) | PASS |
| 21 | 10 | 0 | FAIL | PASS (492) | PASS (441) | PASS |
| 22 | 10 | 0 | FAIL | — | — | PASS |
| 23 | 15 | 1 | PASS (V0) | PASS (461) | PASS (581) | PASS |
| 24 | 15 | 2 | PASS (V0) | PASS (379) | PASS (343) | PASS |
| 25 | 15 | 5 | PASS (V0) | FAIL (273) | FAIL (200) | PASS |
| 26 | 14 | 2 | PASS (V0) | PASS (348) | PASS (310) | PASS |
| 27 | 0 | 2 | FAIL | FAIL (240) | PASS (327) | PASS |
| 28 | 0 | 5 | FAIL | FAIL (155) | FAIL (213) | PASS |

The data from Examples 15-28 in Table 2 illustrate test results for various urethane resin compositions. For those examples using a flame retardant composition that comprised phosphinate in the range of about 14% to about 45% by weight of the composition and an expandable graphite in the range of about 0% to about 2% by weight of the composition, a resin composition was provided that: (a) yielded passing results for flame resistance under the UL 94 standard; (b) met dielectric strength standards of ASTM D149; and (c) exhibited acceptable processability characteristics.

Although the aforementioned detailed description contains many specific details for purposes of illustration, anyone of ordinary skill in the art will appreciate that many variations, changes, substitutions and alterations to the details are within the scope of the invention as claimed. Accordingly, the invention described in the detailed description is set forth without imposing any limitations on the claimed invention. The proper scope of the invention should be determined by the following claims and their appropriate legal equivalents.

1. A composition comprising:
a resin; and
a halogen-free flame retardant composition comprising a phosphinate or phosphinate salt.

2. The composition of claim 1 wherein the phosphinate salt is a metal phosphinate salt.

3. The composition of claim 2 wherein the metal phosphinate salt is an aluminum phosphinate salt or a zinc phosphinate salt.

4. The composition of claim 1 wherein the flame retardant composition comprises from about 4% to about 50% by weight of the total composition.

5. The composition of claim 1 wherein the flame retardant composition further comprises at least one additional material which is substantially free of halogen-containing compounds.

6. The composition of claim 5 herein the at least one additional material includes alumina trihydrate.

7. The composition of claim 5 wherein the at least one additional material includes magnesium hydroxide.

8. The composition of claim 1 further comprising an expandable graphite.

9. The composition of claim 8 wherein the expandable graphite comprises from about 0% to about 5% by weight of the total composition.

10. The composition of claim 1 further comprising a viscosity modifier.

11. The composition of claim 10 wherein the viscosity modifier comprises an aliphatic epoxy ester resin or an epoxidized soybean fatty acid ester.

12. A composition comprising:
a resin comprising an epoxy resin; and
a halogen-free flame retardant composition comprising a phosphinate or phosphinate salt.

13. The composition of claim 12 wherein the phosphinate salt is a metal phosphinate salt.

14. The composition of claim 12 wherein the flame retardant composition further comprises at least one additional material which is substantially free of halogen-containing compounds.

15. The composition of claim 14 wherein the at least one additional material is selected from the group consisting of alumina trihydrate, magnesium hydroxide and mixtures thereof.

16. The composition of claim 12 further comprising an expandable graphite.

17. The composition of claim 12 wherein the flame retardant composition comprises from about 4% to about 50% of the total composition and the expandable graphite comprises from about 0% to about 3% by weight of the total composition.

18. The composition of claim 12 further comprising a viscosity modifier.

19. A composition comprising:
a resin comprising a urethane resin; and
a halogen-free flame retardant composition comprising a phosphinate or phosphinate salt.

20. The composition of claim 19 wherein the phosphinate salt is a metal phosphinate salt.

21. The composition of claim 19 wherein the flame retardant composition further comprises at least one additional material which is substantially free of halogen-containing compounds.

22. The composition of claim 21 wherein the at least one additional material is selected from the group consisting of alumina trihydrate, magnesium hydroxide and mixtures thereof.

23. The composition of claim 19 further comprising an expandable graphite.

24. The composition of claim 23 wherein the flame retardant composition comprises from about 14% to about 45% of the total composition and the expandable graphite comprises from about 0% to about 2% by weight of the total composition.

25. The composition of claim 19 further comprising a viscosity modifier.
